(19) United States
(12) Patent Application Publication
(10) Pub. No.: US 2026/0208410 A1
(43) Pub. Date: Jul. 23, 2026

(54) PROCESS FOR PRODUCING AN OVERMOLDED PART IN AN INJECTION MOLDING APPARATUS

(71) Applicant: SABIC GLOBAL TECHNOLOGIES B.V., Bergen op Zoom (NL)

(72) Inventors: Ilona Maria Francois GROND-SOONS, Schimmert (NL); Davy Wilhelmus Anna BRANDS, Maastricht (NL); Bart VAN DER AAR, Den Dungen (NL); David PELLETIER, Bergen op Zoom (NL)

(21) Appl. No.: 19/141,657

(22) PCT Filed: Dec. 19, 2023
(86) PCT No.: PCT/EP2023/086721

§ 371 Date: Jun. 20, 2025

(30) Foreign Application Priority Data
Dec. 19, 2022 (EP) 22214434.7

(51) Int. Cl. B29C 45/14; B29C 45/64

(52) U.S. Cl. CPC B29C 45/1418; B29C 45/14311; B29C 45/14631; B29C 45/14819; B29C 45/64; B29C 2045/14319; B29K 2715/00

(57) ABSTRACT

A process for producing an overmolded part can include positioning the laminate between a stationary part comprising a mold cavity and a movable part of an injection molding apparatus. The process can include moving the movable part towards the stationary part to transform the laminate into the shape of the mold cavity to form a shaped laminate. The process can include retracting the movable part to form a first injection gap of a selected thickness between a lower surface of movable part and a top surface of shaped laminate. The process can include injecting the top shot of molding material into the first injection gap over the top surface of the shaped laminate to make the overmolded part. The process can include opening the movable part and the stationary part by moving the movable part away from the stationary part.

### TECHNICAL FIELD

The present disclosure relates generally to a process of producing an overmolded part, and more specifically to a process of overmolding a polymeric material over a laminate via injection molding conducted in one-step.

### BACKGROUND

Resin molded articles used in automobiles, home electric appliances, construction materials, etc. can be manufactured by laminating layers or by fusion bonding an outer thermoplastic resin layer to a core thermoplastic resin layer.

JP Pat. No. 59150740, titled “Method for Manufacturing Multilayer Molded Article” discloses a molding method wherein a peripheral edge of the skin material is sandwiched between the skin material fixing plate movably attached to the female mold located below and the female mold, and the core material molten resin is supplied to the upper surface of the skin material for laminating the skin material to the core material.

U.S. Pat. No. 5,154,872, titled “Process for Producing Multilayer Molded Article” discloses a process for producing a multilayer molded article that comprises supplying a skin material between a male mold and a female mold which are attached to clamping.

DE Pat. No. 102015221006A1 disclosed a method comprising introducing a semifinished product for producing a main body of the component in a shaping device, wherein the semifinished product is formed from a continuous fiber-reinforced thermoplastic material; processing the semifinished product in the shaping device for completing the basic body; lifting a machining tool of the molding device of the main body, so that a gap between the machining tool and the base body is formed; supplying coating material to the gap, characterized in that in the inventive method, a coating material is introduced into a gap between the machining tool and the base body, preferably surface irregularities of the base body can be compensated.

JP Pat. No. 2001113558A discloses a co-injection molding apparatus having a plurality of injection devices, which comprises laminating and fusing and integrating a skin sheet, an intermediate material elastomer layer and a core material layer in this order to obtain sufficient weather resistance.

WO 2017/051383A1 discloses a method for forming a part in an injection mold, includes: heating a molding material to a molding temperature; injecting the molding material through a gate and into a molding cavity of the injection molding apparatus of any of the preceding claims; pressing the stationary half and the moving half together to form the molding cavity between the resin mold surface and the insert molding surface; moving the movable mold insert, and thereby moving the insert molding surface and adjusting the molding cavity shape, the molding cavity depth, the molding cavity volume, or a combination comprising at least one of the foregoing along at least a portion of the molding cavity; cooling a surface of the molding cavity with the cooling system; separating the resin mold surface and the moving half mold surface; and ejecting the part from the injection molding apparatus.

The prior approaches have various shortcomings.

### SUMMARY

Under various circumstance where a geometry is complex and the insert needed is not flat but forms a three-dimensional structure, an overmolded article having desired tactile touch characteristics and aesthetics cannot be effectively manufactured due to the imprecise laminate positioning that can result the laminate remaining visible as the material flows to the wrong side of the molded article. The potential reasons for the imprecise laminate position can be the cavity size that leaves a room for the molten resin where the molten resin flows towards the wrong side and a push from the molten resin flow over the heated and soften laminate that directs the soften laminate to the wrong side.

Injection molded parts with structural ribs often suffer from sink marks caused by uneven temperature distribution in the parts. The uneven temperature distribution can cause hot spots at the junction where the ribs are attached to the part. Since the material mass is larger at this junction, it requires a longer cooling time, which can cause this portion to shrink more than surrounding portions. The presence of such sink marks deteriorates the surface of a part.

Overmolding an insert can allow material to flow towards the other side of the part due to the complexity of the shape, resulting in an unaesthetic product having surface defects and recessed portions can lead to sinks and wrinkles.

Existing techniques are incompatible to address these shortcomings that also include creating a part having a complicated shape or a large area of curvature or a complicated part with structural ribs without compromising the aesthetics of the part.

In view of the above, the present disclosure provides a process of producing an overmolded part in one step, in particular a process of overmolding a polymeric material over a laminate in an injection molding apparatus that can be a standalone. The disclosure also relates to the overmolded parts made by the said process. It is an object of the disclosure to provide an overmolded part without impairing the surface properties of the aesthetical part as well as the laminate while maintaining a predetermined shape and position of the laminate. Using the processes disclosed in the disclosure, the forming of an overmolded part can take place in one apparatus and can result in saving of cost and time that eliminates the need of a separate tool.

The disclosure provides a process of producing an overmolded part with structural ribs that can be free of sink marks. The present disclosure provides a process of producing overmolded parts using an injection molding apparatus comprising the movable mold inserts present in the movable part and these movable mold inserts keep the laminate intact at critical locations where the laminate is likely to deviate from the desired shape.

These and other features and characteristics are more particularly described below.

### BRIEF DESCRIPTION OF THE DRAWINGS

The following is a brief description of drawings wherein like elements are numbered alike and which is presented for the purposes of illustrating the different steps of a process for producing an overmolded part and exemplary embodiments disclosed herein and not for the purposes of limiting the same.

FIG. 1(a) is a cross-sectional illustration of an injection molding apparatus in an open position.

FIG. 1(b) is a cross-sectional illustration of the laminate positioned in the injection molding apparatus.

FIG. 1(c) is a cross-sectional illustration of the movable part and the stationary part of the injection molding apparatus when are in a closed position.

FIG. 1(d) is a cross-sectional illustration of an injection gap formed in the injection molding apparatus.

FIG. 1(e) is a cross-sectional illustration of the injection of the top shot of molding material into the injection gap formed as in FIG. 1(d).

FIG. 1(f) is a cross-sectional illustration of the overmolded part.

FIG. 1(g) is a cross-sectional illustration of a multi-layered overmolded part.

FIG. 2(a) is a cross-sectional illustration of an injection molding apparatus with the movable part comprising the movable mold inserts.

FIG. 2(b) is a cross-sectional illustration of an injection molding apparatus of FIG. 2(a) with laminate positioned in it.

FIG. 2(c) is a cross-sectional illustration of an injection molding apparatus of FIG. 2(b) with the movable part and the stationary part in a closed position.

FIG. 2(d) is a cross-sectional illustration of an injection molding apparatus of FIG. 2(c) with the top shot of molding material injected in it.

FIG. 2(e) is a cross-sectional illustration of an injection molding apparatus of FIG. 2(d) with the retraction of the remaining movable mold inserts.

FIG. 3(a) is a cross-sectional illustration of an injection molding apparatus comprising an injection system located in the stationary part.

FIG. 3(b) is a cross-sectional illustration of the laminate positioned in of apparatus of FIG. 3.

FIG. 3(c) is a cross-sectional illustration of the apparatus of FIG. 3(b) where the movable part and the stationary part of the injection molding apparatus are in a closed position.

FIG. 3(d) is a cross-sectional illustration of the apparatus of FIG. 3(c) where the bottom shot of molding material is injected into the injection system located in the stationary part.

FIG. 3(e) is a cross-sectional illustration of the apparatus of FIG. 3(d) where the top shot of molding material is injected into the apparatus.

FIG. 3(f) is a cross-sectional illustration of the overmolded part.

FIG. 3(g) is a cross-sectional illustration of a multi-layered overmolded part.

FIG. 4(a) is a cross-sectional illustration of an injection molding apparatus comprising a movable part comprising movable mold inserts.

FIG. 4(b) is a cross-sectional illustration of apparatus of FIG. 4(a) comprising a laminate positioned in the injection molding apparatus.

FIG. 4(c) is a cross-sectional illustration of apparatus of FIG. 4(b) representing the first movable mold inserts of movable part and the stationary part in a closed position.

FIG. 4(d) is a cross-sectional illustration of apparatus of FIG. 4(c) representing the bottom shot of molding material and the top shot of molding material injected into the apparatus.

FIG. 4(e) is a cross-sectional illustration of FIG. 4(d) representing the movable mold inserts retracted and top shot of molding material injected into the injection molding apparatus.

These figures (also referred to herein as “Fig.”) are merely schematic representations based on convenience and the ease of demonstrating the present disclosure, and are, therefore, not intended to indicate relative size and dimensions of the devices or components thereof and/or to define or limit the scope of the exemplary embodiments.

### DETAILED DESCRIPTION

The process of the present disclosure will be illustrated in details by way of making reference to the accompanied drawings.

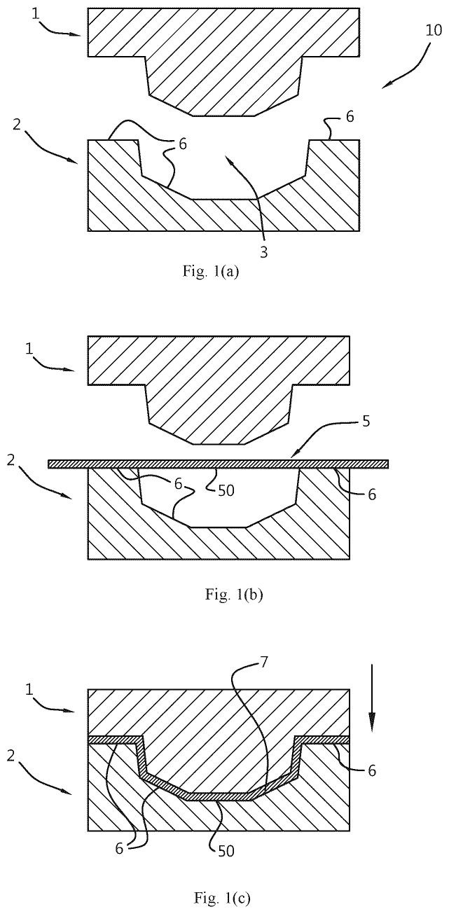

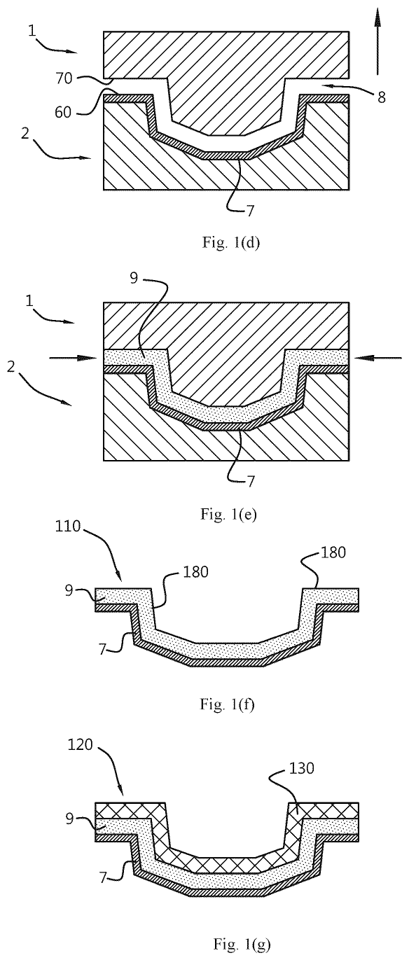

FIG. 1(a) is an illustration of a cross-sectional view of the injection molding apparatus 10 in an open position. The injection molding apparatus 10 can have a stationary part 2 and a movable part 1. In the present invention, the injection molding apparatus 10 can comprise a movable part 1 and a stationary part 2 operably connected together. In the open position, the molding cavity 3 can be disposed between the movable part 1 and the stationary part 2. The molding cavity 3 can be of any shape depending on the desired shape of the overmolded part.

FIG. 1(b) is an illustration of a cross-sectional view of the injection molding apparatus 10 in the open position with a laminate 5 positioned between the stationary part 2 and the movable part 1 of the injection molding apparatus 10. The laminate 5 can be in contact with the top surface 6 of the stationary part 2 of the injection molding apparatus 10.

The laminate can be a fiber-reinforced composite material, whereby high rigidity can be easily obtained. The laminate can comprise various fibers such as glass fibers, carbon fibers or aramid fibers or a combination thereof. The laminate 5 can be pre-heated to a softening temperature, i.e. temperature greater than or equal to at least one of a glass transition temperature or near melting point temperature of the material of the laminate 5 prior positioning between the stationary part 2 and the movable part 1 of the injection molding apparatus 10. The laminate can be pre-heated to a softening temperature that the laminate does not become too soft that the laminate loses its integrity. The thickness of the laminate can range from 0.1 mm to 6 mm, preferably from 0.1 mm to 5 mm or more preferably from 0.1 mm to 4 mm.

FIG. 1(c) is a cross-sectional illustration of the movable part 1 and the stationary part 2 of the injection molding apparatus 10 of FIG. 1 in a closed position. In the closed position, the movable part 1 can be lowered towards the stationary part 1 until it presses the laminate 5 to transform it into the prescribed shape of the mold cavity 3 to form a shaped laminate 7. In the closed position, the lower surface 50 of the shaped laminate 7 can be in contact with the top surface 6 of the stationary part 2 of the injection molding apparatus 10.

FIG. 1(d) is a cross-sectional illustration of an injection gap 8 formed between the lower movable part 1 and the stationary part 2 of the injection molding apparatus 10. The movable part 1 can be retracted in the opposite direction to the stationary part 2 to form a first injection gap 8 between a top surface 60 of the shaped laminate 7 and a lower surface 70, 201 of the movable part 1. The movable part 1 can be configured to move towards the stationary part thereby adjusting a molding cavity shape, a molding cavity depth, a molding cavity volume, or a combination thereof.

FIG. 1(e) is a cross-sectional illustration of the injection molding apparatus 10 comprising the injection of the top shot of molding material 9 into the first injection gap 8. The top shot of molding material 9 can be in the molten state when injected in the first injection gap 8 of the injection molding apparatus 10 formed between the top surface 60 of the shaped laminate 7 and a lower surface 70, 201 of the movable part 1. The top shot of molding material 9 can be injected in the first injection gap 8 till the time the first injection gap 8 can be fully filled with the top shot of molding material 9.

Following the injection of the top shot of molding material 9, the injection molding apparatus 10 can maintain the final shape of the top shot of molding material 9 and the mold can be cooled to solidify the overmolded part 110. The overmolded part 110 can be ejected once the cooling is done for the selected period of time.

The step of FIG. 1(d) can be repeated again to retract the movable part 1 in the opposite direction to the stationary part 2 to form another injection gap between a top surface 180, 271 of the top shot of molding material and a lower surface 70, 201 of the movable part 1 to inject further the top shot of molding material or a molding material 130 different from the top shot of molding material on the top surface 180, 271 of the top shot of molding material to form a multi-layered overmolded part 120.

Post injecting the top shot of molding material or the molding material 130 different from the top shot of molding material on the top surface 180, 271 of the top shot of molding material, the injection molding apparatus 10 can be maintained in the final shape of the multi-layered overmolded part 120. The mold can be cooled to solidify the multi-layered overmolded part 120. The multi-layered overmolded part 120 can be ejected once the cooling is done for the selected period of time.

The step of retracting the movable part to create a passage for the injection of a new molding material over the previously injected molding material followed by injecting the molding material over the previously injected molding material can be repeated multiple times depending upon the number of layers of molding material required for making a multi-layered overmolded part. The multi-layered overmolded part can comprise at least 2 layers. The multi-layered overmolded part can comprise 5 layers or preferably 4 layers or preferably 3 layers or more preferably 2 layers. To make the multi-layered overmolded part, the top shot of molding material or a molding material different from the top shot of molding material can be injected on the top surface of the top shot of molding material.

FIG. 1(f) is a cross-sectional illustration of overmolded part 110. The overmolded part 110 comprises a shaped laminate 7 bonded with the layer comprising the top shot of molding material 9.

FIG. 1(g) is a cross-sectional illustration of a multi-layered overmolded part 120. The multi-layered overmolded part 120 comprises a shaped laminate 7 bonded with the layer comprising the top shot of molding material 9 that is further bonded with the layer comprising the molding material 130 different from the top shot of molding material 9.

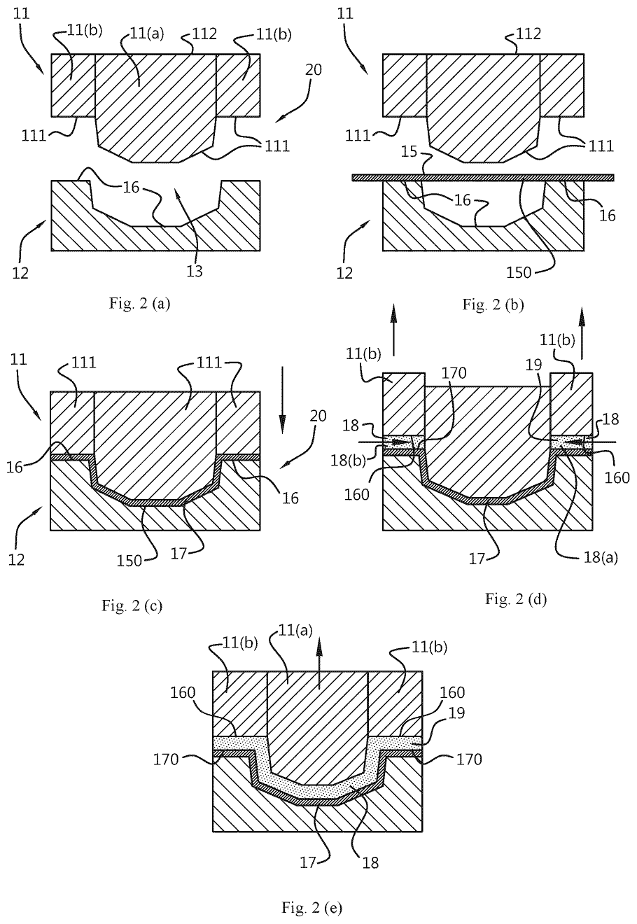

FIG. 2(a) is a cross-sectional illustration of the injection molding apparatus (20) in an open position adapted to carry out the injection molding process of the present disclosure. The injection molding apparatus 20 comprises a stationary part 12 and a movable part 11. The injection molding apparatus 20 comprises the movable part 11 and the stationary part 12 operably connected together or coupled together. The movable part 11 can include movable inserts 111. The movable inserts can include first movable mold insert 11(a) and second movable insert 11(b) or more movable inserts. The movable inserts 111 can be disposed in the movable part 11, the stationary part 12, or can be disposed in both parts. The movable part can comprise one or more movable mold inserts wherein the movable mold inserts are configured to move towards the stationary part, or away from the stationary part. The movable part or the movable mold inserts are configured to move towards the stationary part thereby adjusting a mold cavity depth, a mold cavity volume, or a combination thereof.

The injection molding apparatus 20 of FIG. 2(b) to 2(e) is shown having three movable mold inserts along the cross-section, however the injection molding apparatus 20 can include any number of movable mold inserts. For simplicity, and ease of understanding, reference to the movable mold insert 111 in the following description can refer to any one, or combination of any of the movable mold inserts 111.

FIG. 2(b) is a cross-sectional illustration of an injection molding apparatus 20 with the movable part 11 having the movable mold inserts 111 in an open position. In the open position, a laminate 15 can be positioned between the stationary part 12 and the movable part 11 of the injection molding apparatus 20. The laminate 15 can be a fiber-reinforced composite material, whereby high rigidity is easily obtained. The laminate can comprise various fibers such as glass fibers, carbon fibers or aramid fibers or a combination thereof. The laminate 15 can be pre-heated to a softening temperature i.e. temperature greater than or equal to at least one of a glass transition temperature or near melting point temperature of the material of the laminate 15 prior positioning between the stationary part 12 and the movable part 11 of the injection molding apparatus 20. The laminate can be pre-heated to a softening temperature that the laminate does not become too soft that the laminate loses its integrity. The thickness of the laminate can range from 0.1 mm to 6 mm, preferably from 0.1 mm to 5 mm or more preferably from 0.1 mm to 4 mm.

FIG. 2(c) is a cross-sectional illustration of the movable part 11 having the movable mold inserts 111 and the stationary part 12 of the injection molding apparatus 20 of FIG. 2(b) in a closed position. In the closed position, the movable part 11 comprising the movable inserts 111 can be lowered towards the stationary part 12 until it presses the laminate 15 of FIG. 2(b) to transform it into the prescribed shape of the mold cavity 13 to form a shaped laminate 17. In the closed position, the lower surface 150 of the shaped laminate 17 can be in contact with the top surface 16 of the stationary part 12.

FIG. 2(d) is a cross-sectional illustration of the movable part 11 having the movable mold inserts 111 and the stationary part 12 of the injection molding apparatus 20 of FIG. 2(a) in a partial open position with the first injection gap 18 formed between a lower surface 160 of the second movable inserts 11(a) and a top surface 170 of the shaped laminate 17. The movable mold insert 111 can be in mechanical communication with each other, e.g., hydraulic element (e.g., a piston or ram), pneumatic, electro mechanic a mechanical mechanism (e.g., hydraulic, pneumatic, screw), electromechanical mechanism (e.g., induction), and the like which can move the movable mold insert 111 towards and away from the shaped laminate 17. When the injection molding apparatus 20 is in the partial open position as of FIG. 2(d), the mold cavity 13 of FIG. 2(a), disposed between the second movable mold insert 11(b) and the shaped laminate 17, is correspondingly open to form a first injection gap 18. The first injection gap 18 ca be disposed between the lower surface 160 of second movable mold insert 11(b) and the top surface 170 of shaped laminate 17, can be further defined by a first mold cavity edge 18(a), and a second mold cavity edge 18(b). When in partial open position, as shown in FIG. 2(d), top shot of molding material 19 can be injected through the first injection gap 18. The top shot of molding material 19 can be injected simultaneously or sequentially from the first mold cavity edge 18(a), and a second mold cavity edge 18(b) or sequentially from the second mold cavity edge 18(b), and a first mold cavity edge 18(a).

FIG. 2(e) is a cross-sectional illustration of an injection molding apparatus 20 of FIG. 2(d) in an open position with a first injection gap 18 formed by retracting the first movable mold insert 11(a) of the movable part 11. In this open position, the first movable mold insert 11(a) can retract or move away or backward from the top surface 170 of shaped laminate 17 to form a fully opened first injection gap 18 between the top surface 170 of shaped laminate 17 and the lower surface 160 of the movable part 11. The first movable mold insert 11(a) can be retracted to align with second movable mold inserts 11(b). Retraction of the first movable mold insert 11(a) can be affected through the use of computer numerical control that measures the cavity thickness and uses this to retract the movable mold inserts in such a way that the cavity thickness is maintained constant during the movement of the movable mold inserts. In this way, the top shot of molding material 19 can begin to spread into the remaining volume (e.g., unoccupied volume) of the first injection gap 18. The first movable mold insert 11(a) can be kept in a position such that the thickness of the first injection gap 18 is maintained throughout to make the overmolded part 210.

Post injecting the top shot of molding material 19, the injection molding apparatus 20 can maintain the final shape of the top shot of molding material 19 as the mold can be cooled to solidify the overmolded part. The overmolded part can be ejected once the cooling is done for the selected period of time.

The steps of FIG. 2(d) and FIG. 2(e) can be repeated to form a multi-layered overmolded part. Post injecting the top shot of molding material 19 or the molding material different from the top shot of molding material on the top surface of the top shot of molding material, the injection molding apparatus 20 can be maintained in the final shape of the multi-layered overmolded part. The mold can be cooled to solidify the multi-layered overmolded part. The multi-layered overmolded part can be ejected once the cooling is done for the selected period of time.

Movement of each movable mold insert can overlap one another, e.g., the first movable mold insert can still be moving while subsequent movable mold inserts begin moving. Stated another way, movement of the movable mold inserts can be simultaneous. Furthermore, although described herein where the first movable mold insert is the first to move, it is to be understood that movement of the movable mold inserts can begin at any one of the inserts and is not limited to the first or second movable mold insert moving first. The top shot of molding material can be injected in the first injection gap till the time the first injection gap can be fully filled with the top shot of molding material. Post injecting the first polymeric material, the injection molding apparatus can maintain the final shape of the top shot of molding material as the mold is cooled to solidify the overmolded part. The overmolded part can be ejected once the cooling is done for the selected period of time. The thickness of the top shot of molding material of the overmolded part ranges from 0.2 mm to 10 mm, from 0.2 mm to 7 mm, from 0.2 mm to 5 mm, from 0.2 mm to 4 mm or from 0.2 mm to 3 mm.

The step of retracting the movable mold inserts to create a passage for the injection of a new molding material over the previously injected molding material followed by injecting the molding material over the previously injected molding material can be repeated multiple times depending upon the number of layers of molding material required for making a multi-layered overmolded part. The multi-layered overmolded part can comprise at least 2 layers. The multi-layered overmolded part can comprise preferably 5 layers or preferably 4 layers or preferably 3 layers or more preferably 2 layers. To make the multi-layered overmolded part, the top shot of molding material or a molding material different from the top shot of molding material can be injected on a top surface of the top shot of molding material.

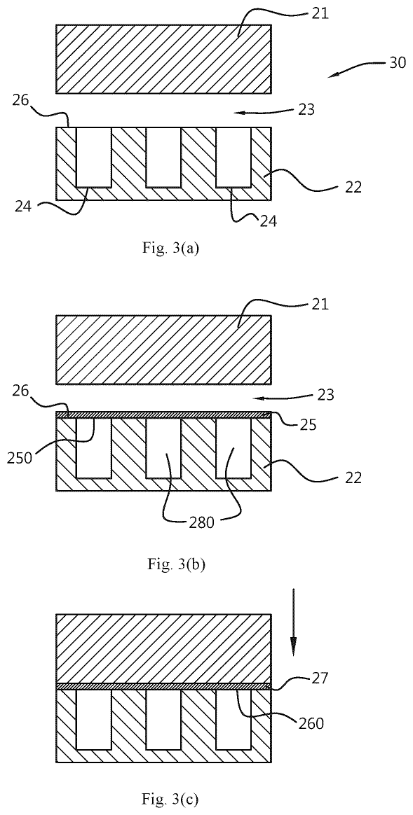

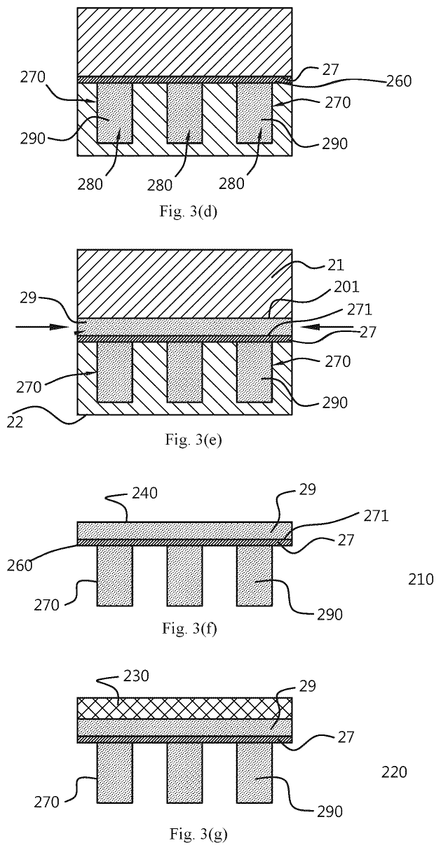

FIG. 3(a) to FIG. 3(e) provide various steps and cross-sectional illustration of an injection molding apparatus used for producing an overmolded part comprising a ribbed structure. FIG. 3(a) is a cross-sectional illustration of the injection molding apparatus 30 adapted to carry out the injection molding process of the present disclosure. The injection molding apparatus 30 can include a stationary part 22 and a movable part 21. The injection molding apparatus 30 comprises the movable part 21 and the stationary part 22 operably connected together. Further as shown in FIG. 3(a), the stationary part 22 of the injection molding apparatus 30 can further comprise an injection system 24. The injection system 24 can be disposed in the stationary part on any face or on any side of the stationary part.

The injection molding apparatus 30 of FIG. 3(b) to 3(e) is shown having three ribs 270 along the cross-section. However, the injection molding apparatus 30 can include any number of ribs 270. For simplicity, and ease of understanding, reference to the ribs 270 in the following description can refer to any one, or combination of any of the ribs 270.

FIG. 3(b) provides the cross-sectional illustration of an injection molding apparatus of FIG. 3(a). A laminate 25 can be positioned between stationary part 22 and the movable part 21 of the injection molding apparatus 30. The laminate 25 can be positioned on the stationary part 21 i.e. the lower surface 250 of the laminate 25 can be in contact with the top surface 26 of the stationary part. The stationary part 22 comprises an injection system 24 that can be configured to inject the bottom shot of molding material 290 of the apparatus 30. The laminate 25 can be a fiber-reinforced composite material, whereby high rigidity can be easily obtained. The laminate can comprise various fibers such as glass fibers, carbon fibers or aramid fibers or a combination thereof. The laminate 25 can be pre-heated to a softening temperature i.e. temperature greater than or equal to at least one of a glass transition temperature or near melting point temperature of the material of the laminate 25 prior positioning between the stationary part 22 and the movable part 21 of the injection molding apparatus 30. The laminate can be pre-heated to a softening temperature that the laminate does not become too soft that the laminate loses its integrity. The thickness of the laminate can range from 0.1 mm to 6 mm, preferably from 0.1 mm to 5 mm or more preferably from 0.1 mm to 4 mm.

FIG. 3(c) is a cross-sectional illustration of the movable part 21 and the stationary part 22 of the injection molding apparatus 30 of FIG. 3(b) in a closed position. In the closed position, the movable part 21 can be lowered towards the stationary part 22 until it presses the laminate 25 to transform it into the prescribed shape of the mold cavity 23 to form a shaped laminate 27. In the closed position, the lower surface 260 of the shaped laminate 27 can be in contact with the top surface 26 of the stationary part 22 comprising the injection system 24 configured to inject the bottom shot of molding material 290.

FIG. 3(d) is a cross-sectional illustration of the injection molding apparatus 30 of FIG. 3(c) in a closed position. The bottom shot of molding material 290 can be injected through the injection system 24 comprising the void 280 located in the stationary part 22 to form a shaped laminate 27 comprising the ribs 270. The bottom shot of molding material 290 can be well bonded with the lower surface 260 of the laminate 27 positioned on the top surface 26 of the stationary part 22. The bonding between the shaped laminate 27 and the ribs 270 formed on the surface 260 of the shaped laminate 27 can be a result of the polymeric interactions induced due to the thermal heating of the polymeric materials.

The ribs can have any variation of structures, including but not limited to honeycombs, webs, perpendicular, diagonal, etc. The number of ribs present is not limited and can be any number of ribs that provide the desired structural integrity to articles made from the ribs.

FIG. 3(e) is a cross-sectional illustration of the first injection gap 28 formed between the movable part 21 and the stationary part 22 of the injection molding apparatus 30. The movable part 21 can be retracted in the opposite direction to the stationary part 22 to form a first injection gap 28 between a top surface 180, 271 of the shaped laminate 27 and the lower surface 70, 201 of the movable part 21. Top shot of molding material 29 can be injected in the first injection gap 28 in the molten form. The movable part 21 can be configured to move thereby adjusting a molding cavity shape, a molding cavity depth, a molding cavity volume, or a combination thereof. Retraction of the movable part 21 can be controlled through the use of computer numerical control that measures the mold cavity 23 thickness and uses this to retract the movable part 21 in such a way that the mold cavity thickness can be maintained constant during the movement of the movable part 21. In this way, the top shot of molding material 29 can begin to spread into the first injection gap 28 formed between the movable part 21 and the shaped laminate 27.

Post injecting the top shot of molding material 29, the injection molding apparatus 30 can maintain the final shape of the top shot of molding material 29 and the bottom shot of molding material 290 as the mold can be cooled to solidify the overmolded part comprising a ribbed structure. The overmolded part comprising the ribbed structure can be ejected once the cooling is done for the selected period of time. The thickness of the top shot of molding material of the overmolded part ranges from 0.2 mm to 10 mm, from 0.2 mm to 7 mm, from 0.2 mm to 5 mm, from 0.2 mm to 4 mm, from 0.2 mm to 3 mm.

The step of FIG. 3(d) can be repeated again to retract the movable part 21 in the opposite direction to the stationary part 22 to form another injection gap between a top surface 240 of the top shot of molding material and a lower surface 70, 201 of the movable part 21 to inject a super shot of molding material 230 different from the top shot of molding material 29 on the top surface 180, 271 of the top shot of molding material 230 to form a multi-layered overmolded part 220.

Post injecting the super shot of molding material 230, the injection molding apparatus 30 can maintain the final shape of the multi-layered overmolded part 220, and the apparatus 30 can be cooled to solidify the multi-layered overmolded part 220. The multi-layered overmolded part 220 can be ejected once the cooling is done for the selected period of time.

The step of retracting the movable part to create a passage for the injection of a new molding material over the previously injected molding material followed by injecting the molding material over the previously injected molding material can be repeated multiple times depending upon the number of layers of molding material required for making a multi-layered overmolded part. The multi-layered overmolded part can comprise at least 2 layers. The multi-layered overmolded part can comprise preferably 5 layers or preferably 4 layers or preferably 3 layers or more preferably 2 layers. To make the multi-layered overmolded part, the top shot of molding material or the bottom shot of molding material or a molding material different from the top shot of molding material and the bottom shot of molding material on the top surface of the top shot of molding material can be injected.

FIG. 3(f) is a cross-sectional illustration of overmolded part 210. The overmolded part 210 comprises a shaped laminate 27 bonded with the top shot of molding material 29. The top surface 180, 271 of the shaped laminate 27 can be bonded with a layer of the top shot of molding material 29. The lower surface 260 of the shaped laminate can be bonded with the ribs 270.

FIG. 3(g) is a cross-sectional illustration of a multi-layered overmolded part 220. The multi-layered overmolded part 220 can comprise the top surface 180, 271 of the shaped laminate 27 bonded with the top shot of molding material 29 that can be further bonded with a layer of the bottom shot of molding material 290 or a layer of the molding material 230 different from the top shot of molding material 29 or the bottom shot of molding material 290. The lower surface 260 of the shaped laminate can be bonded with the bottom shot of molding material 290 injected to make the ribs 270.

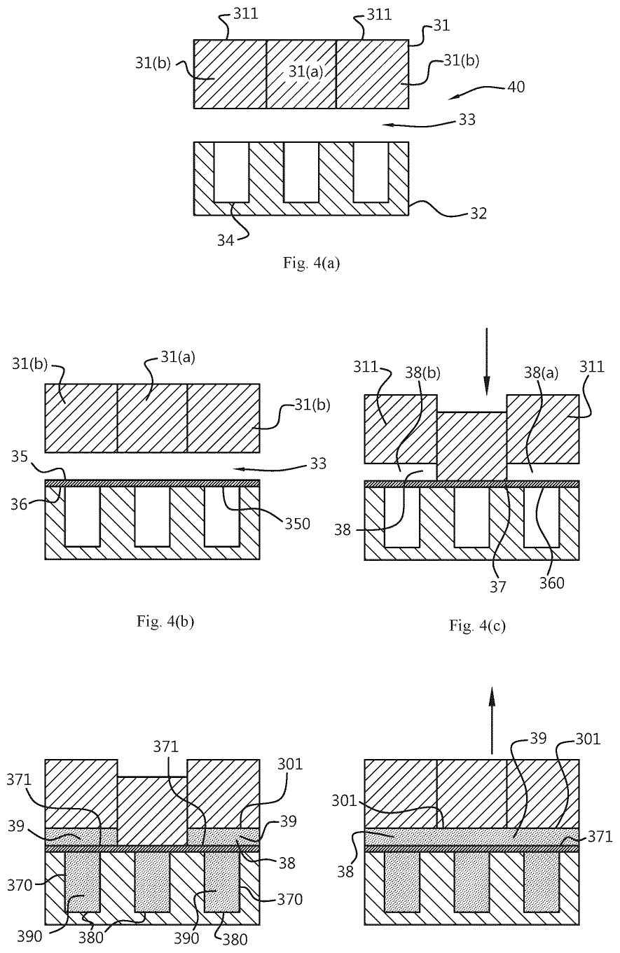

FIG. 4(a) is a cross-sectional illustration of the injection molding apparatus 40 adapted to carry out the injection molding process of the present invention. The injection molding apparatus 40 can have a stationary part 32 and a movable part 31. The injection molding apparatus 40 can comprise the movable part 31 and the stationary part 32 operably connected together. The movable part 31 can include movable mold inserts 311. The movable mold inserts 311 can be disposed in the movable part 31, the stationary part 32, or the movable mold inserts 311 can be disposed in both halves. The movable inserts can include first movable mold insert 31(a) and second movable insert 31(b) or more movable inserts. The movable part 31 can comprise multiple movable mold inserts 311 wherein the movable mold inserts can be configured to move towards the stationary part, or away from the stationary part. The movable part or the movable mold inserts are configured to move towards the stationary part thereby adjusting a mold cavity depth, a mold cavity volume, or a combination thereof.

FIG. 4(a) provides an illustration where the stationary part 32 of the injection molding apparatus 40 can further comprise an injection system 34 located in the stationary part 32. A bottom shot of molding material 390 can be injected through the injection system 34 located in the stationary part 32 of the injection molding apparatus 40. The injection system 34 as located in the stationary part 32 can be located on any face or on any side of the stationary part 32.

The molding apparatus 40 of FIG. 4(a) to 4(e) is shown having three movable mold inserts 311 along the cross-section, however the molding apparatus 40 can include any number of movable mold inserts 311. For simplicity, and ease of understanding, reference to the movable mold insert 311 in the following description can refer to any one, or combination of any of, the movable mold inserts 311.

The molding apparatus 40 of FIG. 4(a) to 4(e) is shown having three ribs 370 along the cross-section, however the molding apparatus 40 can include any number of ribs 370. For simplicity, and ease of understanding, reference to the ribs 370 in the following description can refer to any one, or combination of any of the ribs 370.

FIG. 4(b) provides a cross-sectional illustration of an injection molding apparatus of FIG. 4(a). A laminate 35 can be positioned between stationary part 32 and the movable part 31 of the apparatus 40. The laminate 35 can be positioned on the stationary part 32 i.e. the lower surface 350 of the laminate 35 can be in contact with the top surface 36 of the stationary part 32 comprising the injection system 34 configured to inject the bottom shot of molding material 390. The laminate 35 can be a fiber-reinforced composite material, whereby high rigidity can be easily obtained. The laminate can comprise various fibers such as glass fibers, carbon fibers or aramid fibersor a combination thereof. The laminate 35 can be pre-heated to a softening temperature i.e. to a temperature greater than or equal to at least one of a glass transition temperature or near melting point temperature of the material of the laminate 35 prior positioning between the stationary part 32 and the movable part 31 of the injection molding apparatus 40. The laminate can be pre-heated to a softening temperature that the laminate does not become too soft that the laminate loses its integrity. The thickness of the laminate can range from 0.1 mm to 6 mm, preferably from 0.1 mm to 5 mm or more preferably from 0.1 mm to 4 mm.

FIG. 4(c) is a cross-sectional illustration of the movable part 31 having the movable mold inserts 311 and the stationary part 32 of the injection molding apparatus 40 of FIG. 4(b) in a partial open position with a first injection gap 38 formed between the second movable inserts 31(b) when in open position and the shaped laminate 37. The movable mold inserts 311 can be in mechanical communication with each other e.g., hydraulic element (e.g., a piston or ram), pneumatic, electro mechanic a mechanical mechanism (e.g., hydraulic, pneumatic, screw), electromechanical mechanism (e.g., induction), and the like which can move the movable mold insert 311 towards and away from the shaped laminate 37. When the injection molding apparatus 40 is in the partial open position as of FIG. 4(c), the mold cavity 33, disposed between the second movable mold insert 31(b) and the shaped laminate 37, can be correspondingly open to form the first injection gap 38. In the partial open position, the second movable mold inserts 31(b) can retract from the shaped laminate 37 to form the first injection gap 38. The first injection gap 38, disposed between the lower surface 301 of the second movable mold insert 31(b) and the top surface 371 of the shaped laminate 37, can be further defined by a first mold cavity edge 38(a), and a second mold cavity edge 38(b).

FIG. 4(d) is a cross-sectional illustration of the movable part 31 having the movable mold inserts 311 and the stationary part 32 of the injection molding apparatus 40 of FIG. 4(c). The top shot of molding material 39 can be injected simultaneously from the first mold cavity edge 38(a), and the second mold cavity edge 38(b). The top shot of molding material 39 can be injected sequentially from the second mold cavity edge 38(b), and the first mold cavity edge 38(a) or sequentially from the first mold cavity edge 38(a), and the second mold cavity edge 38(b). The top shot of molding material 39 can be in the molten state when injected in the first injection gap 38. The bottom shot of molding material 390 can also be injected simultaneously or sequentially to the top shot of molding material 39 from the second injection system 34 comprising the void 380 located in the stationary part 32 to form the ribs 370 on the shaped laminate surface 360 in contact with the top surface 36 of the stationary part 32. The bottom shot of molding material 39 can be in the molten state when injected in the injection system 34.

The ribs can have any variation of structures, including but not limited to honeycombs, webs, perpendicular, diagonal, etc. The number of ribs present is not limited and can be any number of ribs that provide the desired structural integrity to articles made from the ribs.

FIG. 4(e) is a cross-sectional illustration of an injection molding apparatus 40 of FIG. 4(d) with a fully opened injection gap 38 formed by moving the first movable mold insert 31(a) of the movable part 31 of the injection molding apparatus 40. In this position, the first movable mold insert 31(a) can retract or move away or backward from the shaped laminate 37 to form a fully open injection gap 38 between the top surface 371 of the shaped laminate 37 and the lower surface 301 of the first movable mold insert 31(a). The first movable mold insert 31(a) can be moved backward to align with second movable mold insert 31(b). Backward movement of the first movable mold insert 31(a) can be affected through the use of computer numerical control that measures the cavity thickness and uses this to retract the movable mold inserts in such a way that the cavity thickness is maintained constant during the movement of the movable mold inserts. In this way, the top shot of molding material 39 can begin to spread into the remaining volume (e.g., unoccupied volume) of the first injection gap 38. The first movable mold insert 31(a) can be kept in a position such that the thickness of the first injection gap 38 can be maintained throughout.

The step of retracting the movable mold inserts to create a passage for the injection of a new molding material over the previously injected molding material followed by injecting the molding material over the previously injected molding material can be repeated multiple times depending upon the number of layers of molding material required for making a multi-layered overmolded part. The multi-layered overmolded part can comprise at least 2 layers. The multi-layered overmolded part can comprise preferably 5 layers or preferably 4 layers or preferably 3 layers or more preferably 2 layers. To make the multi-layered overmolded part, the top shot of molding material or the bottom shot of molding material or a molding material different from the top shot of molding material or the bottom shot of molding material on a top surface of the top shot of molding material can be injected.

It is to be understood that in all the embodiments disclosed herein, movement of each movable mold insert can overlap one another, e.g., the first movable mold insert can still be moving while subsequent movable mold inserts begin moving. Stated another way, movement of the movable mold inserts can be simultaneous. Furthermore, although described herein where the first movable mold insert is the first to move, it is to be understood that movement of the movable mold inserts can begin at any one of the inserts and is not limited to the first or second movable mold insert moving first. The top shot of molding material can be injected in the first injection gap till the time the first injection gap can be fully filled with the top shot of molding material. Post injecting the top shot of molding material, the injection molding apparatus can maintain the final shape of the top shot of molding material as the mold is cooled to solidify the overmolded part comprising the ribs. The overmolded part comprising the ribs can be ejected once the cooling is done for the selected period of time.

In all the above processes, the surface of the overmolded part can include a Class A surface (e.g., at a minimum, such surfaces can be smooth, glossy, and weatherable). As used herein, the term “Class A surface” is given the general meaning known in the art and refers to a surface substantially free of visible defects such as hair-lines, pin-holes and the like. For example, a Class A surface can include a gloss of greater than 100 units at either 20° or 60°, a wavescan of less than 5 units (long as well as short), and a distinctness of image (DOI) of greater than 95 units.

The above process sequences (FIG. 1(a) to FIG. 1(e); FIG. 2(a) to FIG. 2(e); FIG. 3(a) to Fig. (e) and FIG. 4(a) to FIG. 4(e)) can also allow the manufacture of large (e.g. parts having a projected area of greater than or equal to 1.2 m², for example, greater than or equal to 2 m², for example, greater than or equal to 3 m²) through the injection molding process. The part can be ejected with the use of ejector pins. The thickness of the top shot of molding material of the overmolded part ranges from 0.2 mm to 10 mm, from 0.2 mm to 7 mm, from 0.2 mm to 5 mm, preferably from 0.2 mm to 4 mm or more preferably from 0.2 mm to 3 mm.

The injection molding process as illustrated in the above figures (FIG. 1(a) to FIG. 1(e); FIG. 2(a) to FIG. 2(e); FIG. 3(a) to Fig. (e) and FIG. 4(a) to FIG. 4(e)) can include cooling a portion of the overmolded part until a cooling criteria is satisfied, cooling the overmolded part until a surface temperature of the part decreases below a glass transition temperature of the molding material, holding the injection molding apparatus in a closed position for a specified time duration, holding the injection molding apparatus in a closed position until the temperature of the mold wall reaches the required temperature or a combination thereof.

A rapid temperature-changing injection molding process (“heat and cool”) can be used in any of the processes disclosed herein. Use of such a rapid temperature-changing injection molding process can increase melt fluidity in the filling stage of the injection molding cycle and can further improve part quality. The heat and cool process generally includes raising the mold wall temperature above the thermoplastic polymer's glass transition temperature or melting temperature during the filling stage, followed by rapid cooling. Rapid cooling refers to cooling at a rate of 5 to 50 degrees per second. Use of the heat and cool method can result in a 20% to a 25% decrease in overall cycle time for making a part. The heat and cool process can assist in making the molding of larger part (e.g., greater than or equal to 1 m²) easier and can reduce the appearance and number of seams between inserts. Processing benefits can include longer, more uniform holding pressure, even in areas far from the gate, which can lower injection pressure and clamping requirements; improved flow lengths; reduction of internal part stresses; and reduction or elimination of weld lines, jetting, silver streaks, or sink marks. Other benefits can include improved replication of minute mold-surface details and improved part surface finish. Thermal cycling of the mold can eliminate post-mold downstream operations such as sanding, annealing, priming, and painting to hide surface defects.

The top shot of molding material and the bottom shot of molding material used in all the above processes can be any material. The top shot of molding material, the bottom shot of molding material, the laminate and the molding material different from the top shot of molding material or the bottom shot of molding material comprises a same or a different polymeric material. The top shot of molding material, the bottom shot of molding material, the laminate and the molding material different from the top shot of molding material or the bottom shot of molding material can be same or different based on the end requirements and the compatibility of the materials to bond with each other. The top shot of molding material or the bottom shot of molding material can include a polymeric material (e.g., including an oligomer), a metallic material, a glass, or a combination including at least one of the foregoing.

The top shot of molding material or the bottom shot of molding material or the molding material different from the top shot of molding material or the bottom shot of molding material or the laminate comprises a polymeric material selected from polycarbonates, blends of polycarbonate, polystyrenes, copolymers of polycarbonate and styrene, polyphenylene ether-polystyrene blends, polyimides, acrylonitrile-styrene-butadiene (ABS), polyalkylmethacrylates, polyesters, polyolefins, polyamides, polyarylates, polysulfones, polyphenylene sulfides, polytetrafluoroethylenes, polyethers, polyacrylics, polyacetals, polybenzoxazoles, polybenzothiazoles, polyoxadiazoles, polypyrazinoquinoxalines, polypyromellitimides, polyquinoxalines, polybenzimidazoles, polyoxindoles, polyoxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls, polysulfonates, polysulfides, polyureas, polyphosphazenes, polysilazanes, polysiloxanes, and combinations thereof, as well as their blends or recycling products. The polymeric material can have any microstructure including branched units.

Possible polymeric resins that can be employed include, but are not limited to, oligomers, polymers, ionomers, dendrimers, copolymers such as graft copolymers, block copolymers (e.g., star block copolymers, random copolymers, etc.) and combinations comprising at least one of the foregoing. Examples of such polymeric resins include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, and combinations comprising at least one of the foregoing.

More particularly, the polymeric can include, but is not limited to, polycarbonate resins (e.g., LEXAN™ resins, commercially available from SABIC's Innovative Plastics business such as LEXAN™ XHT, LEXAN™ HFD, etc.), polyphenylene ether-polystyrene blends (e.g., NORYL™ resins, commercially available from SABIC's Innovative Plastics business), polyetherimide resins (e.g., ULTEM™ resins, commercially available from SABIC's Innovative Plastics business), polybutylene terephthalate-polycarbonate blends (e.g., XENOY™ resins, commercially available from SABIC's Innovative Plastics business), copolyestercarbonate resins (e.g. LEXAN™ SLX or LEXAN™ FST resins, commercially available from SABIC's Innovative Plastics business), acrylonitrile butadiene styrene resins (e.g., CYCOLOY™ resins, commercially available from SABIC's Innovative Plastics business), polyetherimide/siloxane resins (e.g., SILTEM™, commercially available from SABIC's Innovative Plastics business), polypropylene resins, for example, long glass fiber filled polypropylene resins (e.g., STAMAX™ resins, commercially available from SABIC's Innovative Plastics business), and combinations comprising at least one of the foregoing resins.

The polymeric material can include additives ordinarily incorporated into polymer compositions of this type, with the proviso that the additive(s) are selected so as to not significantly adversely affect the desired properties of the injection molded part. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, anti-ozonants, thermal stabilizers, anti-corrosion additives, flow promoters, pigments, dyes radiation stabilizers (e.g., infrared absorbing), flame retardants, and anti-drip agents. A combination of additives can be used, for example a combination of a heat stabilizer, mold release agent, and ultraviolet light stabilizer. In general, the additives are used in the amounts generally known to be effective. The total amount of additives (other than any impact modifier, filler, or reinforcing agent) is generally 0.001 wt % to 5 wt %, based on the total weight of the polymeric material composition. A molding material can include reinforcing materials, such as glass, carbon, basalt, aramid, or combination comprising at least one of the foregoing. Reinforcing materials can include cut, chopped, strand fibers, or a combination comprising at least one of the foregoing. For example, the reinforcing materials can include cut glass fibers, strand glass fibers, or a combination comprising at least one of the foregoing.

The term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terms “a” and “an” are defined as one or more unless this disclosure explicitly requires otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named. “Or” means “and/or.” The suffix “(s)” as used herein is intended to include both the singular and the plural of the term that it modifies, thereby including one or more of that term (e.g., the film(s) includes one or more films).

1. A process to make an overmolded part using an injection molding apparatus including a movable part and a stationary part that are operably couple, the process comprising:
a) pre-heating a laminate to a softening temperature;
b) positioning the laminate between a mold cavity of the stationary part and the movable part;
c) forming the laminate by moving the movable part towards the stationary part, wherein the laminate is formed into a shape defined by the mold cavity to form a shaped laminate, with a lower surface of the shaped laminate in contact with a top surface of the stationary part;
d) retracting the movable part and forming a first injection gap having a selected thickness between a lower surface of movable part and a top surface of shaped laminate;
e) injecting a top shot of molding material into the first injection gap over the top surface of the shaped laminate and forming the overmolded part;
f) cooling the overmolded part with a cooling system;
g) opening the movable part and the stationary part by moving the movable part away from the overmolded part; and
h) ejecting the overmolded part from the injection molding apparatus.

2. The process of claim 1, wherein a void is defined between the shaped laminate and the stationary part, and comprising injecting a bottom shot of molding material into the void and forming a ribbed structure onto the lower surface of the shaped laminate.

3. The process of claim 2, comprising reacting the bottom shot of molding material with the shaped laminate to form a polymer bond between the bottom shot of molding material and the shaped laminate.

4. The process of claim 3, comprising injecting the bottom shot of molding material simultaneously or sequentially to the injection of the top shot of molding material to form the overmolded part comprising the ribbed structure.

5. The process of claim 4, wherein after step e) and prior to step f), the process comprises retracting the movable part to create another injection gap of a selected thickness to inject a super shot of molding material onto a top surface of the top shot of molding material to form a multi-layered overmolded part.

6. The process of claim 5, wherein injecting the top shot, bottom shot, and super shot comprises injecting different polymers.

7. The process of claim 5, wherein injecting two of the top shot, bottom shot, and super shot comprises injecting the same polymer.

8. The process of claim 7, wherein the movable part comprises one or more movable mold inserts, comprising moving the one or more movable mold inserts towards the stationary part or away from the stationary part to form one or more of the shaped laminate, the top shot of molding material and the bottom shot of molding material.

9. The process of claim 8, wherein the movable mold inserts are configured to move simultaneously or sequentially to each other, towards the stationary part or away from the stationary part.

10. The process of claim 9, wherein the movable part or the movable mold inserts are configured to move towards the stationary part, for adjusting a mold cavity depth, a mold cavity volume, or a combination thereof.

11. An overmolded part formed by the process of claims 1.

12. The overmolded part of claim 11, wherein the overmolded part comprises the overmolded part comprising a ribbed structure or a multi-layered overmolded part or a multi-layered overmolded part comprising the ribbed structure.

13. The overmolded part of claim 12, wherein the top shot of molding material comprises a polymeric material selected from polycarbonates, blends of polycarbonate, polystyrenes, copolymers of polycarbonate and styrene, polyphenylene ether-polystyrene blends, polyimides, acrylonitrile-styrene-butadiene (ABS), polyalkylmethacrylates, polyesters, polyolefins, polyamides, polyarylates, polysulfones, polyphenylene sulfides, polytetrafluoroethylenes, polyethers, polyacrylics, polyacetals, polybenzoxazoles, polybenzothiazoles, polyoxadiazoles, polypyrazinoquinoxalines, polypyromellitimides, polyquinoxalines, polybenzimidazoles, polyoxindoles, polyoxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls, polysulfonates, polysulfides, polyureas, polyphosphazenes, polysilazanes, polysiloxanes, and combinations thereof, as well as their blends or recycling products.

14. The overmolded part of claim 13, wherein the laminate comprises a fiber-reinforced composite material.

15. The overmolded part of claim 14, wherein a thickness of the laminate ranges from 0.1 mm to 6 mm, preferably from 0.1 mm to 5 mm or more preferably from 0.1 mm to 4 mm.

16. An injection molding apparatus to form an overmolded part, the apparatus comprising
a movable part having a lower surface; and
a stationary part having a top surface, wherein the movable part and the stationary part are operably coupled,
wherein a mold cavity is defined between the stationary part and the movable part, and the mold cavity is configured to receive a laminate;
wherein the movable part is configured to move toward the stationary part, to form the laminate into a shape defined by the mold cavity and thereby form a shaped laminate, such that the shaped laminate has a top surface that faces the movable part and a lower surface in contact with the top surface of the stationary part;
wherein the movable part is configured for being retracted from the shaped laminate to define a first injection gap, having a selected thickness, between the lower surface of movable part and the top surface of shaped laminate; and
wherein the apparatus is configured to inject a top shot of molding material into the first injection gap, over the top surface of the shaped laminate, to thereby form a top structure against the top surface of the shaped laminate, and thereby form the overmolded part.

17. The apparatus of claim 16, wherein:
a void is defined in the movable part; and
the apparatus is configured to inject a bottom shot of molding material into the void and thereby form a ribbed structure onto the lower surface of the shaped laminate.

18. The apparatus of claim 17, wherein:
the movable part comprises one or more movable mold inserts,
wherein the one or more movable mold inserts are configured for being moved towards the stationary part or away from the stationary part to form one or more of the shaped laminate, the top shot of molding material and the bottom shot of molding material.

19. The apparatus of claim 18, wherein:
the movable mold inserts are configured to move simultaneously or sequentially to each other, towards the stationary part or away from the stationary part, to adjust a mold cavity depth, a mold cavity volume, or a combination thereof.

20. An overmolded part formed with the apparatus of claim 19, comprising:
a shaped laminate having a top surface and a bottom surface; and
one or more of: a ribbed structure coupled to the bottom surface of the shaped laminate; and one or more top structures layered on top of each other over the top surface of the shaped laminate.
